(19) United States
(12) Patent Application Publication
(10) Pub. No.: US 2011/0200783 A1
(43) Pub. Date: Aug. 18, 2011

(54) CELLULOSIC STAPLE FIBER AND ITS USE

(75) Inventors: Gert Kroner, Lenzing (AT); Heinrich Firgo, Vocklabruck (AT); Johann Manner, Weyregg (AT); Peter Sulek, Vocklabruck (AT); Hans-Herbert Sulek, (US)

(73) Assignee: LENZING AKTIENGESELLSCHAFT, Wein (AT)

(21) Appl. No.: 13/095,438

(22) Filed: Apr. 27, 2011

Related U.S. Application Data
(63) Continuation of application No. 12/649,851, filed on Dec. 30, 2009, now abandoned.
Application No. 12/649,851 is a continuation of application No. 11/810,522, filed on Jun. 6, 2007, now abandoned.
Application No. 11/810,522 is a continuation of application No. PCT/AT2005/000493, filed on Dec. 7, 2005.

(30) Foreign Application Priority Data
Dec. 10, 2004 (AT) A2083/2004
Feb. 17, 2005 (AT) A256/2005

(51) Int. Cl. D02G 3/22; D02G 3/36; B32B 33/00; C09K 3/00; C08K 5/04

(52) U.S. Cl. 428/91; 428/359; 428/361; 252/182.12; 524/36

(57) ABSTRACT

The present invention relates to the use of a multilobal cellulosic staple fiber as a filling fiber. Furthermore, the invention relates to a cellulosic staple fiber which is characterized in that

the cross-section of the fiber has three or more lobes

the titer of the fiber is 1.0 to 30 dtex, preferably more than 3.0 dtex, especially more than 5.0 dtex, preferably 5.6 to 10 dtex, especially preferred more than 6.0 dtex, especially 6.3 to 10 dtex

the wet modulus of the fiber fulfils the following formula:

Wet modulus (cN/tex)≧0.5*√IT wherein T is the titer of the fiber in dtex

the breaking strength of the fiber in the conditioned state fulfils the following formula:

Breaking Strength (cNitex)≧1.3*√T+2*T wherein T is the titer of the fiber in dtex.

### CROSS REFERENCE TO RELATED APPLICATION

This application claims the benefit of Title 35, United States Code, Section 120 as a continuation of U.S. Ser. No. 12/649,851 filed Dec. 30, 2009, which is a continuation of U.S. Ser. No. 11/810,522 filed Jun. 6, 2007 and a continuation of International Patent Application No. PCT/AT2005/000493, filed on Dec. 7, 2005.

### BACKGROUND OF THE INVENTION

1. Field of the Invention

The present invention relates to the field of filling materials for textile objects such as duvets, cushions, pillows, mattresses, fleeces for upholstery, clothing and the like, and to materials which are especially useful therefor.

It is known that filling materials for textile objects must meet special requirements. Especially, high bulk with a low density at the same time, and suitable properties with regard to heat insulation, moisture adsorption and moisture transport are desired. WO 99/16705 proposes a filling material consisting of a non-woven mixture of polyester fibers and Lyocell fibers. Lyocell fibers are cellulosic fibers which are spun from a solution of cellulose in an aqueous tertiary amine oxide, especially N-methyl-N-morpholine-N-oxide (NMMO).

EP 1 067 227 A1 discloses a mixed fiber fleece of polyester fibers and viscose fibers as a filling material.

The known filling materials, be it that they consist of one single fiber type or of fiber mixtures, or of mixtures of fibers with other materials, e.g. down, are still not fully satisfactory with regard to their properties.

### SUMMARY OF THE INVENTION

It is an object of the present invention to provide a filling material which excellently fulfils the requirements that are to be met by such materials.

This object is achieved according to one aspect with a cellulosic staple fiber according to independent claim 1.

In a further aspect, this object is achieved by the use of a multilobal cellulosic staple fiber, and, especially, by the use of the cellulosic staple fiber according to the present invention, as a filling material.

A further aspect of the present invention relates to a filling material containing a multilobal cellulosic staple fiber, especially the cellulosic staple fiber according to the present invention.

Preferred embodiments of the present invention are disclosed in the dependent claims.

### DESCRIPTION OF THE DRAWINGS

FIG. 1 shows fiber cross-sections of exemplary multilobal fibers made in accordance with the invention as described in Example 1 below.

FIG. 2 shows fiber cross-sections of exemplary multilobal fibers made in accordance with the invention as described in Example 3 below.

FIG. 3 shows fiber cross-sections of exemplary multilobal fibers made in accordance with the invention as described in Example 4 below.

### DETAILED DESCRIPTION OF THE INVENTION

The present invention is based on the discovery that multilobal cellulosic staple fibers are excellently suitable as a filling fiber for various textile uses, especially for duvets, cushions, pillows, mattresses, fleeces for upholstery, clothing and the like.

By “multilobal” cellulosic staple fibers, fibers are to be understood the cross-section of which exhibits three or more lobes. Such fibers can be produced by spinning a cellulose spinning solution through spinnerets, the openings of which exhibit three or more lobes having a ratio between length and width of the lobes of preferably 2:1 or more, respectively. The fibers thus produced exhibit a cross-section which, throughout the plurality of fibers, is substantially the same.

A process for the production of multilobal cellulosic staple fibers is described, for example, in EP-A 0 301 874. However, this document solely discloses the use of such fibers for absorbent products, such as e.g. tampons.

A further process for the manufacture of cellulosic staple fibers by spinning a spinning solution through a spinneret with multi-lobed openings is disclosed in WO 04/85720.

JP-A 61-113812 as well as Treiber E., Chemiefasern 5 (1967), 344-348 (“Verzug, Verstreckung and Querschnittsmodifizierung beim Viskosespinnen”) disclose the manufacture of cellulosic (endless) filaments by spinning a spinning solution through a spinneret with multi-lobed openings. The properties of (endless) filaments are pronouncedly different from those of staple fibers, especially with regard to the crimping properties.

It can be shown that multilobal cellulosic staple fibers possess a spectrum of properties which renders them particularly useful as a filling material. Especially, fibers of this kind exhibit a high flexural stiffness, high bulk, high rebound capacity and a high water absorption capacity.

Preferably the titer of the multilobal cellulosic staple fiber used according to the present invention is 1.0 to 30 dtex, preferably more than 3.0 dtex, especially more than 5.0 dtex, preferably 5.6 to 10 dtex, especially preferred more than 6.0 dtex, especially 6.3 to 10 dtex.

The suitable range of titers in each case depends on the envisaged use of the filling material. When used as a filling fiber for clothing, rather a lower decitex in the range of 1 dtex to 5 dtex, preferably about 3 dtex to 4 dtex, is advantageous. A typical titer for textile applications is in the range of about 3.3 dtex.

In the field of filling material for duvets, cushions, and the like, a titer in the range of from more than 5.0 dtex to 10 dtex is preferred. Here, a typical titer lies in the range of about 6.7 dtex.

Particularly useful as a filling fiber is a cellulosic staple fiber, which is characterized in that

the cross-section of the fiber has three or more lobes

the titer of the fiber is 1.0 to 30 dtex, preferably more than 3.0 dtex, especially more than 5.0 dtex, preferably 5.6 to 10 dtex, especially preferred more than 6.0 dtex, especially 6.3 to 10 dtex

the wet modulus of the fiber fulfils the following formula:

Wet modulus (cN/tex)≧0.5*√T wherein T is the titer of the fiber in dtex

the breaking strength of the fiber in the conditioned state fulfils the following formula:

Breaking Strength (cNitex)≧1.3*√T+2*T wherein T is the titer of the fiber in dtex.

A fiber having this combination of features has not yet been disclosed in the state of the art.

This multilobal cellulosic staple fiber is a so-called “Modal” fiber. The term “Modal fiber” is a generic name by which according to the definition of BISFA (Bureau for the International Standardization of Man-Made-Fibers) a cellulosic fiber with a high wet tenacity and a high wet modulus (i.e. the force which is required to elongate the fiber in the wet condition by 5%) is to be understood.

The multilobal cellulosic staple fiber according to the present invention possesses a spectrum of properties which excellently fulfils the requirements which are to be met by a filling fiber. Especially the higher flexural stiffness as compared with common Modal fibers is to be mentioned. For example, a common Modal fiber with a titer of 6.5 dtex exhibits a flexural stiffness of 0.35 mN mm²/tex², whereas a multilobal Modal fiber according to the present invention exhibits, with the same titer, a flexural stiffness of 0.44 mN mm²/tex².

The flexural stiffness is measured by a method developed by the applicant. The measured value is displayed as the relation of the gradient of the force to path over a linear measuring range, based on the titer.

In order to carry out the measurement, a conditioned fiber is clamped into a clamping bar and cut with a cutting device to a length of exactly 5 mm. The clamping bar is moved upwardly at constant speed by an electric gear. Thereby, the fiber is pressed onto a small sensor plate which is adapted to a force sensor. The stiffer the fiber, the higher is the measured force.

Due to the lack of possibilities to calibrate, no effective force is given for the calculation of the flexural stiffness. However, it is possible to make a relative comparison of fibers in a specified measuring range. Thereby, the gradient is measured in a linear measuring range of the measured force over the path and related to the titer of the fiber.

In the cellulosic staple fiber according to the present invention, the numeric relation between area F of the fiber cross-section and the perimeter U of the fiber cross-section is preferably from 1.7:1 to 3.5:1. In this embodiment, the lobes of the fiber cross-section are comparatively thicker and shorter. The numeric relation between the area of the cross-section of the fiber and the perimeter of the fiber can be determined by software-based calculation from a micro-photograph of the fiber cross-section.

In a further preferred embodiment, the area of the fiber cross-section is larger by a factor of 2.30-fold or more, preferably 2.50-fold or more, especially preferred 2.70-fold and more, than the area of the largest equilateral triangle which is inscribed into said cross-section. This resembles a more distinct development of the form of the lobes of the fiber. The ratio between the area of the fiber cross-section and the area of the largest equilateral triangle that can be inscribed, is determined by the method which is described in detail in WO 04/85720. This ratio is, in the following, referred to as the “Delta-factor”.

It can be shown that the multilobal Modal staple fibers according to the invention exhibit a very high water absorption capacity.

Preferably, the fiber according to the invention exhibits a Syngina absorption capacity of more than 6.0 g/g, preferably 6.5 g/g or more, especially preferred 6.8 g/g and more.

The Syngina absorption capacity is calculated according to the test method disclosed in WO 04/85720.

If the absorption capacity is determined according to the EDANA test method ERT 350.0-02, values of 4.5 g/g and more are achieved.

For the use of the cellulosic staple fiber as a filling fiber it is, furthermore, advantageous, if the fiber exhibits on its surface a substance increasing the slippage, especially silicone. Such substances can be applied in a manner known per se during the fiber production in the baths of the after-treatment and finishing steps. An amount of the substance increasing the slippage, especially of silicone, from 0.3 weight % to 3.0 weight %, based on the weight of the fiber, is advantageous.

The multilobal Modal fiber according to the invention is not only suitable as a filling fiber but can also be used for other textile applications, such as e.g. for yarns and the like, in the common titer range of from 1.0 dtex to 5.0 dtex. Thereby, voluminous and bulky yarns can be produced, for example. These yarns are characterized by an increased air lock, an improved area coverage, a better moisture transport and an increased heat insulation.

The cellulosic staple fiber according to the invention, furthermore, is outstandingly useful as a material for carpets or carpeted floors. In this case, the titer range of the fiber is preferably about 6.0 dtex or more.

A process for the production of Modal fibers not having a lobal cross-section is known e.g. from AT 287.905 B. If, when carrying out such a process, a spinneret with multilobal, preferably trilobal openings is used, the multilobal Modal fibers according to the invention can be produced. Preferably, spinnerets with openings the lobes of which have a ratio of length to width of lower than 3:1 are used.

The filling material which can be obtained by using a multilobal cellulosic staple fiber, especially the multilobal Modal fiber according to the invention, may be present in the form of a fleece, a fiberball, a wadding, or in other forms known to the skilled artisan.

In a preferred embodiment, the filling material according to the invention essentially consists of the multilobal cellulosic staple fiber.

For many applications, however, the use of several components, i.e. the multilobal cellulosic staple fiber on the one hand, and further materials, such as e.g. further fibers and/or further filling components on the other hand is suitable as a filling material.

The fiber which can be used as the further component may preferably be selected from the group consisting of synthetic fibers, especially polyester fibers, polyacrylic fibers, polyamide fibers, polylactate fibers; natural fibers, especially cotton, kapok, bast fibers, sisal, silk; man-made cellulosic fibers, especially viscose fibers, Modal fibers, Lyocell fibers; and/or animal hair, especially sheep wool, horsehair, rabbit wool, camel hair and cashmere.

As a further component, not being in fiber form, a material of the group consisting of down and feathers may be selected.

Polyester fibers and/or down are especially preferred as the further components for the filling material according to the invention.

If several components are used, the multilobal cellulosic staple fiber is preferably present in an amount of from 20 weight % to 90 weight %, based on the whole filling material.

If several components are used as a filling material, the skilled artisan is aware of various assemblies:

First, the components may be present mixed with another as a so-called “intimate mixture”.

Furthermore, assemblies are known which are composed of various fleece-like layers. The multilobal cellulosic staple fiber (as a pure material or, again, mixed with another component) is used in at least one of these fleece-like layers.

In the filling material according to the invention, the multilobal cellulosic staple fiber may also be used in a modified form, e.g. inherently flame-retardant by incorporation of a flame-retardant agent (such as Exolit® 5060 by Messrs. Clariant), aftertreatment with a flame-retardant agent or otherwise modified in a flame-retardant fashion. In this regard, it is advantageous to form so-called cellulose/clay nanocomposites wherein the clay component of said nanocomposite comprises a material selected from the group consisting of unmodified clays and modified clays, such as hydrophobically or hydrophilically modified clays. The clay component may preferably comprise a montmorillonite or a modified or unmodified hectorite clay.

The multilobal cellulosic staple fiber may, furthermore, be modified by a compound selected from the group consisting of chitosan and chitosonium polymers. Especially, it is advantageous to modify the fiber by coating the fiber with chitosan. The use of chitosonium polymers to modify Lyocell fibers is known from WO 2004/007818.

Multilobal cellulosic staple fibers modified with chitosan or a chitosonium polymer exhibit the known properties of chitosan, i.e. antimicrobial activity, positive influence on wound healing, odour repressive properties and antiallergenic properties, rendering these fibers especially useful as a filling material.

The invention is described in more detail by way of the following nonlimiting working examples and the figures.

### EXAMPLES

### Example 1

Viscose pulp with an R18-content of 93% was alkalized with mashing lye containing 240 g/l sodium hydroxide under stirring at 35° C. Addition of the pulp and discharging of the slurry were performed continuously via a pump. The slurry was pressed off to a fleece of alkalized cellulose containing 33% cellulose and 17% sodium hydroxide.

The fleece of alkalized cellulose was shredded. The alkalized cellulose was ripened at a temperature of 30° C., so that the copper viscosity of the cellulose was 16 mPa.s before sulfidizing. By addition of 38% CS₂, based on cellulose, sulfidation was performed in a sulfidation plant at 28° C. for two hours while circulating the mass. The xanthogenate was dissolved with a dilute sodium hydroxide solution to a viscose with 6.1% cellulose, 6.5% NaOH and 36% CS₂, based on cellulose.

The viscose was filtered three times and de-aerated. 1 hour before spinning 3.0%, based on cellulose, of a modifying agent (ethoxylated amines) effecting a mantle structure were added to the viscose. The viscose was ripened to a spinning gamma value of 57. Viscosity during spinning was 80 ball-fall seconds. The viscose was spun on a commercial spinning device through spinnerets with 625 trilobal holes, each having 3 lobes of 72×33 μm (ratio of length to width: 2.18), into a spinning bath having the following composition:

70 g/l sulfuric acid

90 g/l sodium sulfate

55 g/l zinc sulfate

Temperature of the spin bath was 40° C. The coagulated and partly regenerated filament strand, which had a pale yellowish colour, was led over a first godet (G1) into a second bath, the temperature of which was 95° C., and was stretched there between G1 and a second godet (G2) by 75%. The final draw-off speed was 20 m/min.

The spinning tow was cut to staples with a length of 60 mm, which then were fully regenerated in diluted sulfuric acid, thereafter washed with hot water until they were acid-free, desulfurized with dilute sodium lye, again washed, bleached with dilute sodium hypochlorite solution, again washed, finished with a silicone emulsion, pressed off and dried.

The fibers, having a titer of 6.8 dtex, had the following properties:

| Fiber tenacity (conditioned state): | 29 cN/tex |
|---|---|
| Fiber tenacity (wet state): | 17 cN/tex |
| Elongation (conditioned): | 16% |
| Elongation (wet): | 18% |
| Wet modulus: | 3.75 cN/tex/5% |
| Syngina-Value (test method according to WO | 7.0 g/g |
| 04/85720): | |
| Water retention capacity: | 62% |
| Ratio of area of fiber cross-section to fiber cross- | 2.1:1 |
| section perimeter: | |
| Delta-factor: | 2.6 |

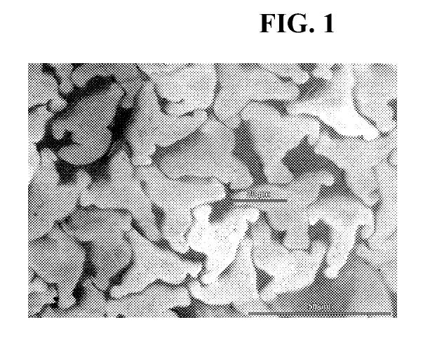

FIG. 1 shows fiber cross-sections of the fibers spun according to example 1.

### Example 2

An eucalyptus pulp with an R18-content of 97.5% was alkalized with mashing lye containing 220 g/l sodium hydroxide under stirring at 50° C. Further treatment of the slurry and sulfidation were performed in the same manner as described in example 1. The xanthogenate was dissolved with a dilute sodium hydroxide solution to a viscose with 6.3% cellulose, 6.2% NaOH and 36% CS₂, based on cellulose.

Further treatment of the viscose was performed in the same manner as described in example 1. The viscose was spun on a commercial spinning device through spinnerets with 625 trilobal holes, each having 3 lobes of 72×33 μm (ratio of length to width: 2.18) into a spinning bath having the following composition:

72 g/l sulfuric acid

90 g/l sodium sulfate

53 g/l zinc sulfate

Temperature of the spin bath was 42° C. Further treatment of the spun filaments was performed in the same manner as described in example 1.

The fibers, having a titer of 7.6 dtex, had the following properties:

| Fiber tenacity (conditioned state): | 30 cN/tex |
|---|---|
| Fiber tenacity (wet state): | 19 cN/tex |
| Elongation (conditioned): | 17% |
| Elongation (wet): | 20% |
| Wet modulus: | 3.5 cN/tex/5% |
| Syngina-Value (test method according to | 6.8 g/g |
| WO 04/85720): | |
| Water retention capacity: | 61% |
| Ratio of area of fiber cross-section to fiber | 1.9:1 |
| cross-section perimeter: | |
| Delta-factor: | 2.55 |

### Example 3

A hardwood pulp with an R18-content of 94% was alkalized with mashing lye containing 220 g/l sodium hydroxide under stirring at 45° C. Further treatment of the slurry and sulfidation were performed in the same manner as described in example 1. The xanthogenate was dissolved with a dilute sodium hydroxide solution to a viscose with 5.9% cellulose, 6.1% NaOH and 36% CS2, based on cellulose.

Further treatment of the viscose was performed in the same manner as described in example 1. The viscose was spun on a commercial spinning device through spinnerets with 625 trilobal holes, each having 3 lobes of 70×30 nm (ratio of length to width: 2.33) into a spinning bath having the following composition:

68 g/l sulfuric acid

95 g/l sodium sulfate

55 g/l zinc sulfate

Temperature of the spin bath was 37° C. Further treatment of the spun filaments was performed in the same manner as described in example 1.

The fibers, having a titer of 6.1 dtex, had the following properties:

| Fiber tenacity (conditioned state): | 30 cN/tex |
|---|---|
| Fiber tenacity (wet state): | 19 cN/tex |
| Elongation (conditioned): | 18% |
| Elongation (wet): | 20% |
| Wet modulus: | 4.1 cN/tex/5% |
| Syngina-Value (test method according to | 6.85 g/g |
| WO 04/85720): | |
| Water retention capacity: | 62% |
| Ratio of area of fiber cross-section to fiber cross- | 2.5:1 |
| section perimeter: | |
| Delta-factor: | 2.8 |

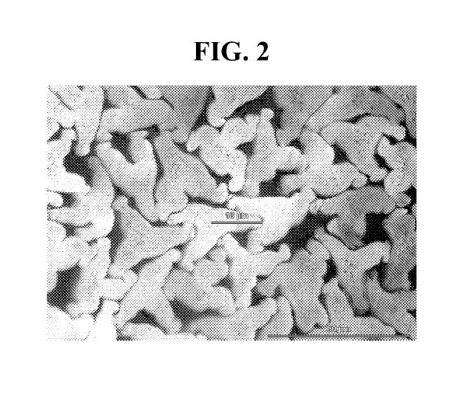

FIG. 2 shows fiber cross-sections of the fibers spun according to example 3.

### Example 4

An eucalyptus pulp with an R18-content of 97.5% was alkalized with mashing lye containing 220 g/l sodium hydroxide under stirring at 50° C. Further treatment of the slurry and sulfidation were performed in the same manner as described in example 1. The xanthogenate was dissolved with a dilute sodium hydroxide solution to a viscose with 6.1% cellulose, 6.2% NaOH and 36% CS2, based on cellulose.

Further treatment of the viscose was performed in the same manner as described in example 1. The viscose was spun on a commercial spinning device through spinnerets with 625 trilobal holes, each having 3 lobes of 70×30 μm (ratio of length to width: 2.33) into a spinning bath having the following composition:

72 g/l sulfuric acid

95 g/l sodium sulfate

53 g/l zinc sulfate

Temperature of the spin bath was 42° C. Further treatment of the spun filaments was performed in the same manner as described in example 1.

The fibers, having a titer of 3.3 dtex, had the following properties:

| Fiber tenacity (conditioned state): | 27 cN/tex |
|---|---|
| Fiber tenacity (wet state): | 18 cN/tex |
| Elongation (conditioned): | 10% |
| Elongation (wet): | 12% |
| Wet modulus: | 6.5 cN/tex/5% |
| Syngina-Value (test method according to | 6.3 g/g |
| WO 04/85720): | |
| Water retention capacity: | 74% |
| Ratio of area of fiber cross-section to fiber cross- | 2.6:1 |
| section perimeter: | |
| Delta-factor: | 2.6 |

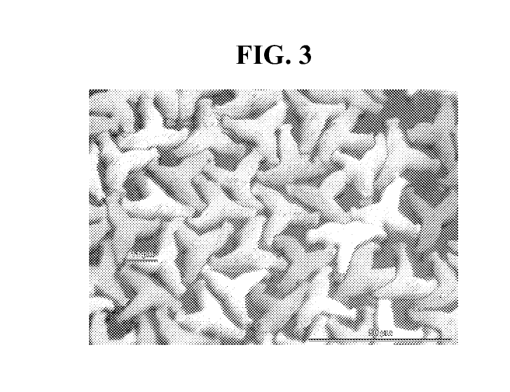

FIG. 3 shows fiber cross-sections of the fibers spun according to example 4.

### Example 5

Using a trilobal Modal staple fiber produced according to example 1, fleeces were produced which were used as a filling material for duvets.

Thereby,

a) a fleece of 100% of the fiber produced according to example 1

b) a fleece of 70% of the fiber produced according to example 1 and 30% polyester fiber

c) a fleece of 50% of the fiber produced according to example 1 and 50% polyester fiber

were produced.

In all cases the fleeces had excellent evenness.

What is claimed is:

1. A cellulosic staple fiber, wherein
a cross-section of the fiber has three or more lobes
the titer of the fiber is 1.0 to 30 dtex, preferably more than 3.0 dtex, especially more than 5.0 dtex, preferably 5.6 to 10 dtex, especially preferred more than 6.0 dtex, especially 6.3 to 10 dtex
the wet modulus of the fiber fulfils the following formula:
Wet modulus (cN/tex)≧0.5*√T wherein T is the titer of the fiber in dtex
the breaking strength of the fiber in the conditioned state fulfils the following formula:
Breaking Strength (cN/tex)≧1.3*√T+2*T wherein T is the titer of the fiber in dtex.

2. The cellulosic staple fiber according to claim 1, wherein the numeric relation between area F of the fiber cross-section and the perimeter U of the fiber cross-section is preferably from 1.7:1 to 3.5:1.

3. The cellulosic staple fiber according to claim 1 or 2, wherein the area of the fiber cross-section is higher by a factor of 2.30-fold or more, preferably 2.50-fold or more, especially preferred 2.70-fold and more, than the area of the largest equilateral triangle which is inscribed in this cross-section.

4. The cellulosic staple fiber according to one of claim 1, 2 or 3, wherein the Syngina absorption capacity of the fiber is more than 6.0 g/g, preferably 6.5 g/g or more, especially preferred 6.8 g/g and more.

5. The cellulosic staple fiber according to one of the preceding claims, wherein the fiber exhibits on its surface a substance increasing the slippage, especially silicone.

6. The cellulosic staple fiber according to one of the preceding claims, wherein the fiber is modified by a compound selected from the group consisting of chitosan and chitosonium polymers.

7. The cellulosic staple fiber according to one of the preceding claims, wherein the fiber is modified by a flame-retardant agent, preferably a modified or unmodified clay.

8. Use of a multilobal cellulosic staple fiber as a filling fiber.

9. Use according to claim 8 as a filling fiber for duvets, cushions, pillows, mattresses, fleeces for upholstery, clothing and the like.

10. Use according to claim 8 or 9, wherein the titer of the multilobal cellulosic staple fiber is 1.0 to 30 dtex, preferably more than 3.0 dtex, especially more than 5.0 dtex, preferably 5.6 to 10 dtex, especially preferred more than 6.0 dtex, especially 6.3 to 10 dtex.

11. Use according to any of claims 8 to 10, wherein the cellulosic staple fiber is modified by a compound selected from the group consisting of chitosan and chitosonium polymers.

12. Use according to any of claims 8 to 11, wherein the cellulosic staple fiber is modified by a flame-retardant agent, preferably a modified or unmodified clay.

13. Use according to any of claims 8 to 12, wherein a cellulosic staple fiber according to any of claims 1 to 7 is used.

14. A filling material for duvets, cushions, pillows, mattresses, fleeces for upholstery, clothing or the like, wherein the filling material comprises a multilobal cellulosic staple fiber.

15. The filling material according to claim 14, wherein the titer of the multilobal cellulosic staple fiber is 1.0 to 30 dtex.

16. The filling material according to claim 14, wherein the multilobal cellulosic staple fiber is modified by a compound selected from the group consisting of chitosan and chitosonium polymers.

17. The filling material according to claim 14, wherein the multilobal cellulosic staple fiber is modified by a flame-retardant agent.

18. The filling material according to any of claims 14 to 17, wherein a cellulosic staple fiber according to any of claims 1 to 7 is used.

19. The filling material according to claim 14, wherein the filling material consists essentially of the multilobal cellulosic staple fiber.

20. The filling material according to claim 14, wherein the filling material further comprises an additional fiber or filling component, or combinations thereof

21. The filling material according to claim 20, wherein the additional fiber or filling component is selected from the group consisting of synthetic fibers, natural fibers, man-made cellulosic fibers, or combinations thereof

22. The filling material according to claim 20 wherein the additional filling component is selected from the group consisting of down and feathers.

23. The filling material according claim 14, wherein the filling material is in the form of a fibre ball.

24. The filling material according claim 14, wherein the filling material is composed of various fleece-like layers, and wherein at least one of said layers contains the multilobal cellulosic staple fiber.

25. The filling material according to claim 15, wherein the titer of the multilobal cellulosic staple fiber is more than 3.0 dtex.

26. The filling material according to claim 15, wherein the titer of the multilobal cellulosic staple fiber is more than 5.0 dtex.

27. The filling material according to claim 15, wherein the titer of the multilobal cellulosic staple fiber is from about 5.6 to 10 dtex.

28. The filling material according to claim 15, wherein the titer of the multilobal cellulosic staple fiber is more than 6.0 dtex.

29. The filling material according to claim 15, wherein the titer of the multilobal cellulosic staple fiber is from about 6.3 to 10 dtex.

30. The filling material according to claim 17, wherein the flame-retardant agent is selected from the group consisting of a modified claim, a unmodified clay and combinations thereof

31. The filling material according to claim 21, wherein the synthetic fibers are selected from the group consisting of polyester fibers, polyacrylic fibers, polyamide fibers, polylactate fibers and combinations thereof; the natural fibers are selected from the group consisting of cotton, kapok, bast fibers, sisal, silk and combinations thereof; the man-made cellulosic fibers are selected from the group consisting of viscose fibers, Modal fibers, Lyocell fibers and combinations thereof; and the animal hair is selected from the group consisting of sheep wool, horsehair, rabbit wool, camel hair, cashmere, and combinations thereof

32. A filling material for duvets, cushions, pillows, mattresses, fleeces for upholstery, and clothing,
wherein the filling material comprises a multilobal cellulosic staple fiber,
wherein a numeric relation between an area of a fiber cross-section and a perimeter of the fiber cross-section is from 1.7:1 to 3.5:1,
wherein the area of the fiber cross-section is higher by a factor of 2.30-fold or more than an area of a largest equilateral triangle which is inscribed in the fiber cross-section, and
wherein a Syngina absorption capacity of the fiber is more than 6.0 g/g.
